(19) United States
(12) Patent Application Publication
(10) Pub. No.: US 2018/0075461 A1
(43) Pub. Date: Mar. 15, 2018

(54) CUSTOMER BEHAVIOR ANALYSIS DEVICE AND CUSTOMER BEHAVIOR ANALYSIS SYSTEM

(71) Applicant: PANASONIC INTELLECTUAL PROPERTY MANAGEMENT CO., LTD., Osaka (JP)

(72) Inventor: Kunio HIRAKAWA, Fukuoka (JP)

(73) Assignee: PANASONIC INTELLECTUAL PROPERTY MANAGEMENT CO., LTD., Osaka (JP)

(21) Appl. No.: 15/564,571

(22) PCT Filed: Nov. 12, 2015
(86) PCT No.: PCT/JP2015/005655

§ 371 Date: Oct. 5, 2017

(30) Foreign Application Priority Data
Apr. 17, 2015 (JP) 2015-085044

(51) Int. Cl. G06Q 30/02

(52) U.S. Cl. CPC G06Q 30/0201; G06Q 30/0269; G06Q 30/0254; G06Q 30/016; G06Q 30/0255; G06Q 30/0206; G06Q 30/0204

(57) ABSTRACT

Acquiring first customer image information related to a photographed image of a customer when entering a store, acquiring second customer image information related to a photographed image of the customer when advancing into an accounting area, acquiring third customer image information related to a photographed image of the customer leaving the accounting area, acquiring purchase information related to a product purchase status of a customer, measuring an excursion time for each customer on the basis of the first and second customer image information, correlating the excursion time and purchase information for each customer on the basis of the third customer image information, and generating analysis information in which the excursion time and purchase information for each customer are collected, and presenting the analysis information to a user.

### TECHNICAL FIELD

The present invention relates to a customer behavior analysis device and a customer behavior analysis system which analyze a relationship between a customer behavior and a product purchase status in a store on the basis of video photographed in the store.

### BACKGROUND ART

In stores such as supermarkets and convenience stores, opportunity loss, that is, loss (lost profit) caused by loss of opportunity for customers to purchase products due to the circumstances of the store, is a problem, and since this opportunity loss has a big influence on store sales, it is necessary to take measures to reduce opportunity loss. In considering improvement measures related to such opportunity loss, it is desirable to analyze behaviors related to customer product purchasing in the store and to grasp the opportunity loss situation at the store based on these analysis results.

In relation to such customer behavior analysis in stores, a technique is known in the related art in which images photographed by a plurality of cameras installed in a store are analyzed to acquire the customer's location in the store, the time spent therein, and the orientation of the customer's face and this information is used to acquire information related to the product to which the customer is paying attention, the degree of interest of the customer with respect to specific products, and the like (refer to PTL 1). In addition, a technique is also known in which cameras are respectively provided to photograph images of customers entering from the entrance of the store, customers moving in the store, and customers paying the purchase price of the products in the accounting area and the photographed images of each camera are used to acquire information related to the behavior status of the customer in the store (refer to PTL 2).

### CITATION LIST

### Patent Literature

PTL 1: Japanese Patent No. 4125634

PTL 2: Japanese Patent Unexamined Publication No. 2010-113692

### SUMMARY OF THE INVENTION

A customer behavior analysis device of the present invention is a customer behavior analysis device which analyzes a relationship between a customer behavior and a product purchase status in a store on the basis of video photographed in the store, the customer behavior analysis device including a processor, and a memory which stores instructions, in which the processor executes the following as the instructions stored in the memory, acquiring first customer image information related to a photographed image of a customer when entering a store, acquiring second customer image information related to a photographed image of the customer when advancing into an accounting area, acquiring third customer image information related to a photographed image of the customer at any point in time from a start of accounting work of a purchased product until leaving the accounting area, acquiring purchase information related to a product purchase status of a customer, measuring an excursion time for each customer on the basis of the first and second customer image information, correlating the excursion time and purchase information for each customer on the basis of the third customer image information, and generating analysis information in which the excursion time and purchase information for each customer are collected, and presenting the analysis information to a user.

In addition, a customer behavior analysis system of the present invention is a customer behavior analysis system which analyzes a relationship between a customer behavior and a product purchase status in a store on the basis of video photographed in the store, the customer behavior analysis system including a camera that photographs an interior of the store, and a plurality of information processing devices provided with a processor and a memory which stores instructions, in which any one of the plurality of information processing devices executes the following as the instructions stored in the memory by the processor. Acquiring first customer image information related to a photographed image of a customer when entering a store, acquiring second customer image information related to a photographed image of the customer when advancing into an accounting area, acquiring third customer image information related to a photographed image of the customer at any point in time from a start of accounting work of a purchased product until leaving the accounting area, acquiring purchase information related to a product purchase status of a customer, measuring an excursion time for each customer on the basis of the first and second customer image information, correlating the excursion time and purchase information for each customer on the basis of the third customer image information, and generating analysis information in which the excursion time and purchase information for each customer are collected, and presenting the analysis information to a user.

According to the present invention, since the excursion time for each customer is measured and the excursion time and purchase information for each customer are correlated on the basis of video photographed in a store, it is possible to obtain analysis information making it possible for the user to accurately grasp the opportunity loss situation in the store.

### BRIEF DESCRIPTION OF DRAWINGS

FIG. 1 is an overall configuration diagram of a customer behavior analysis system according to the present embodiment.

FIG. 2 is a plan view of a store which illustrates the store layout and an installation state of cameras 1a to 1c.

FIG. 3 is an explanatory diagram which shows a situation where first and second cash register cameras 1b and 1c photograph images of customers.

FIG. 4 is an explanatory diagram which illustrates an outline of processes performed by cameras 1a to 1c and PC 3.

FIG. 5 is a functional block diagram which shows a schematic configuration of PC 3.

FIG. 6 is a flowchart which shows an order of processes according to time measurement performed by PC 3.

FIG. 7 is an explanatory diagram which shows a person verification screen displayed on monitor 7.

FIG. 8A is an explanatory diagram which shows a graph which represents analysis information output by printer 8.

FIG. 8B is an explanatory diagram which shows a graph which represents analysis information output by printer 8.

### DESCRIPTION OF EMBODIMENT

Prior to describing the embodiments of the present invention, a brief description will be given of the problems in the related art. In order to grasp the opportunity loss situation at the store, it is effective to compare behavior related to customer product purchasing in the store and the customer product purchase status in the store, specifically, purchasing information such as the purchase price (customer unit price) and the number of purchased products for each customer and to analyze the relationship between the two. At this time, in particular, as the information related to the customer's behavior, the time needed for the customer to select the product to be purchased (not including the accounting wait time) after entering the store is important, that is, the time from the customer entering the store to search for the desired product and migrate around the store (excursion time).

However, according to the related art technique described above, there is a problem in that the time related to the behavior of the customer merely takes into consideration the staying time spent in a specific area in the store, but does not consider the excursion time of the customer, and it is not possible to obtain analysis information making it possible for the user to accurately grasp the opportunity loss situation in the store.

The present invention was created in order to solve the problems of the related art and the main object thereof is to provide a customer behavior analysis device and customer behavior analysis system formed so as to make it possible to obtain analysis information making it possible for a user to accurately grasp the opportunity loss situation in a store on the basis of video photographed in a store.

A first invention made to solve the above problem is a customer behavior analysis device which analyzes a relationship between a customer behavior and a product purchase status in a store on the basis of video photographed in the store, the customer behavior analysis device including a processor, and a memory that stores instructions, in which the processor executes the following as instructions stored in the memory. Acquiring first customer image information related to a photographed image of a customer when entering a store, acquiring second customer image information related to a photographed image of the customer when advancing into an accounting area, acquiring third customer image information related to a photographed image of the customer at any point in time from a start of accounting work of a purchased product until leaving the accounting area, acquiring purchase information related to a product purchase status of a customer, measuring an excursion time for each customer on the basis of the first and second customer image information, correlating the excursion time and purchase information for each customer on the basis of the third customer image information, and generating analysis information in which the excursion time and purchase information for each customer are collected, and presenting the analysis information to a user.

According to this, since the excursion time for each customer is measured and the excursion time and purchase information for each customer are correlated on the basis of video photographed in the store, it is possible to obtain analysis information making it possible for the user to accurately grasp the opportunity loss situation in the store.

In addition, in a second invention, a purchase price for each customer is acquired as purchase information and analysis information is generated by correlating the excursion time and the purchase price for each customer.

Due to this, since analysis information is generated by correlating the excursion time and purchase price for each customer, it is possible for the user to accurately grasp the opportunity loss situation in the store.

In addition, in a third invention, a number of purchased products for each customer is acquired as the purchase information, and an accounting wait time for each customer is measured on the basis of the second and third customer image information, and the analysis information is generated by correlating the accounting wait time and the number of purchased products for each customer.

Due to this, since analysis information is generated by correlating the accounting wait time and the number of purchased products for each customer, it is possible for the user to accurately grasp the opportunity loss situation in the store.

In addition, in a fourth invention, when newly acquired first customer image information is for the same person as previously acquired first customer image information, the excursion time is measured based on the latest first customer image information.

Due to this, it is possible to avoid erroneous measurement of the excursion time based on the previously acquired first customer image information.

In addition, in a fifth invention, the excursion time and the purchase price for each customer are collected for each predetermined unit period, an average excursion time for each unit period and a customer unit price which is an average purchase price for each unit period are calculated, and display information displaying temporal transition statuses of the average excursion time and the customer unit price in a comparable manner is generated as the analysis information.

Due to this, since the temporal transition statuses of the average excursion time and the customer unit price are displayed in a comparable manner, it is possible for the user to accurately grasp the opportunity loss situation in the store.

In addition, in a sixth invention, the accounting wait time for each customer and the number of purchased products for each customer are collected for each predetermined unit period, an average accounting wait time for each predetermined unit period and an average number of purchased products for each predetermined unit period are calculated, and display information displaying temporal transition statuses of the average accounting wait time and the average number of purchased products in a comparable manner is generated as the analysis information.

Due to this, since the temporal transition statuses of the average accounting wait time and the average number of purchased products are displayed in a comparable manner, it is possible for the user to accurately grasp the opportunity loss situation in the store.

In addition, a seventh invention is a customer behavior analysis system which analyzes a relationship between a customer behavior and a product purchase status in a store on the basis of video photographed in the store, the customer behavior analysis system including a camera that photographs an interior of the store, and a plurality of information processing devices provided with a processor and a memory which stores instructions, in which any one of the plurality of information processing devices executes the following as the instructions stored in the memory by the processor. Acquiring first customer image information related to a photographed image of a customer when entering a store, acquiring second customer image information related to a photographed image of the customer when advancing into an accounting area, acquiring third customer image information related to a photographed image of the customer at any point in time from a start of accounting work of a purchased product until leaving the accounting area, acquiring purchase information related to a product purchase status of a customer, measuring an excursion time for each customer on the basis of the first and second customer image information, correlating the excursion time and purchase information for each customer on the basis of the third customer image information, and generating analysis information in which the excursion time and purchase information for each customer are collected, and presenting the analysis information to a user.

Due to this, similarly to the first invention, it is possible to obtain analysis information on the basis of video photographed in the store making it possible for the user to accurately grasp the opportunity loss situation in the store.

A description will be given below of embodiments of the present invention with reference to the drawings.

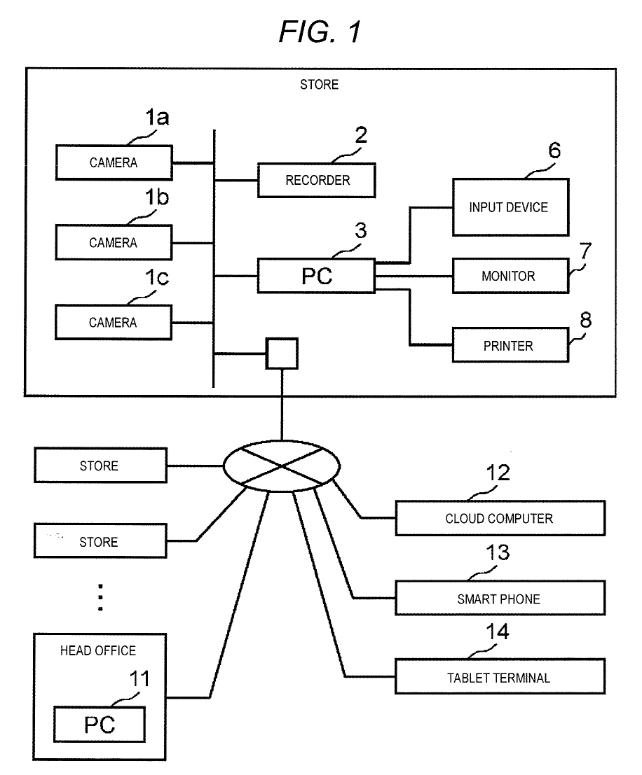

FIG. 1 is an overall configuration diagram of a customer behavior analysis system according to the present embodiment. This customer behavior analysis system is constructed for stores such as supermarkets and is provided with cameras 1a to 1c, recorder (video storage device) 2, and PC (customer behavior analysis device) 3.

Cameras 1a to 1c are installed at appropriate places in the store, the interior of the store is photographed by cameras 1a to 1c, and video of the interior of the store photographed by cameras 1a to 1c is stored in recorder 2.

PC 3 is connected with input device 6 such as a mouse for a user such as a store manager to perform various input works, monitor (display device) 7 for displaying a monitor screen, and printer 8. PC 3 is installed at an appropriate place in the store and it is possible for the user to view the video of the interior of the store photographed by cameras 1a to 1c in real time on the monitor screen displayed on monitor 7 or it is possible to view the past video of the interior of the store recorded in recorder 2.

In addition, cameras 1a to 1c, recorder 2, and PC 3 are installed in each of a plurality of stores, and a PC 11 is installed in the head office which oversees a plurality of stores, and, on PC 11, it is possible to view the images of the interiors of the stores photographed by cameras 1a to 1c in real time or it is possible to view the past images in the stores recorded in recorder 2, and, due to this, it is possible to confirm the situations in the stores in the head office.

PC 3 installed in the store is configured as a customer behavior analysis device which analyzes the behavior of customers who visit the store and it is possible to view the analysis information generated by PC 3 on PC 3 itself and it is also possible to transfer the information to PC 11 installed in the head office view so as to view the analysis information on PC 11, and PCs 3 and 11 are configured as viewing devices for the viewing the analysis information. PCs 3 and 11 have a processor (CPU) and a program memory. The CPU of PC 3 is realized by executing a monitoring program (instructions). These programs may be installed in PC 3 as an information processing device in advance and configured as a dedicated device, or may be provided to a user recorded in an appropriate program recording medium or via a network as an application program operating on a general-purpose OS.

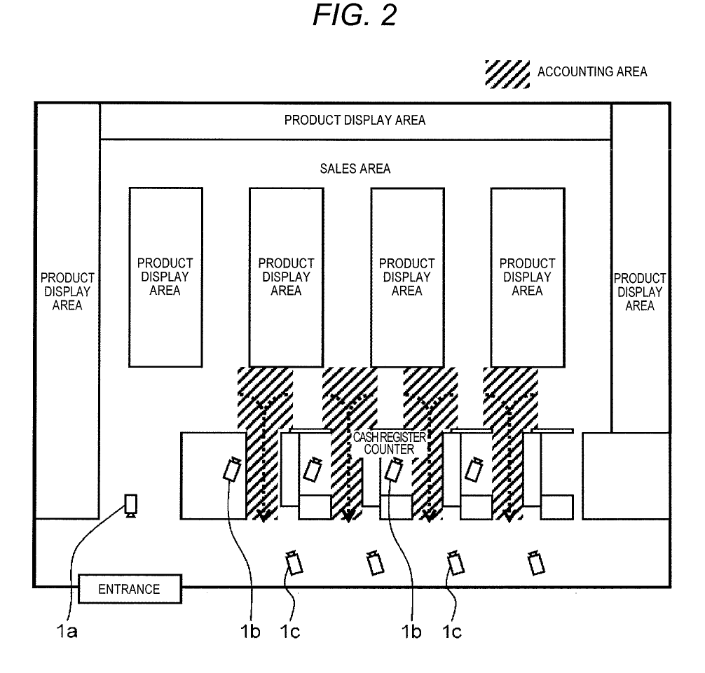

Next, a description will be given of the store layout shown in FIG. 1 and the installation state of cameras 1a to 1c. FIG. 2 is a plan view of the store which illustrates the store layout and the installation state of cameras 1a to 1c.

The store is provided with an entrance, a product display area, a cash register counter, and the like. A customer enters from the entrance and exit and walks around the sales area in the store searching for a desired product, and when a product to be purchased is decided, the customer goes to the cash register counter with the product, finishes at the cash register counter (payment), and then leaves from the entrance and exit. When a customer carries out the accounting at the cash register counter, the customer advances into the accounting area set around the cash register counter from the product display area side, and leaves the accounting area after finishing the accounting.

In addition, in the store, a plurality of cameras 1a to 1c for photographing images of customers who visit the store are installed. Cameras 1a to 1c are installed at appropriate positions on the ceiling in the store. In the present embodiment, entrance cameras 1a for photographing images of a customer entering from an entrance of a store, first cash register cameras 1b for photographing images of a customer entering the accounting area, and second cash register cameras 1c for photographing images of a customer leaving the accounting area are installed. Cameras 1a to 1c are installed so as to photograph images of the face of the customer substantially from the front, such that it is possible to detect a person from the image photographed by cameras 1a to 1c.

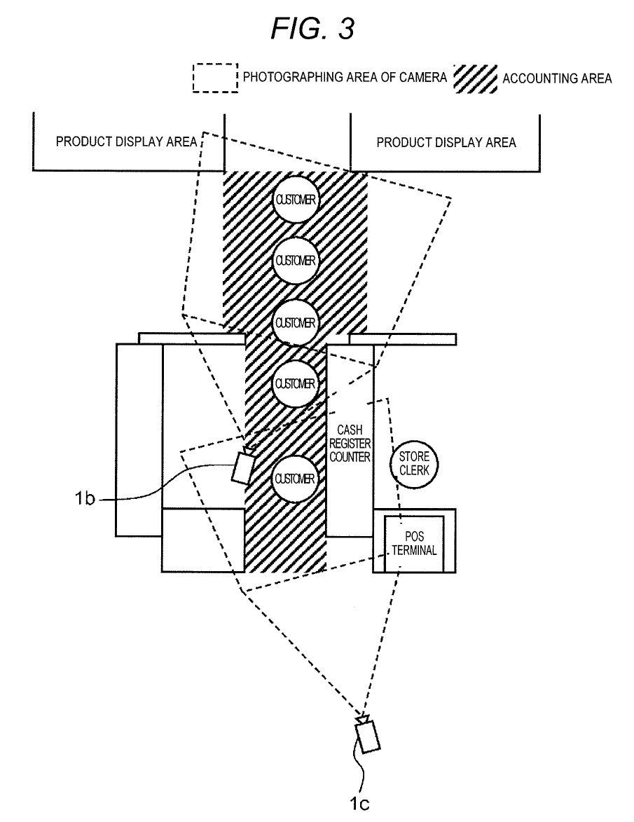

Next, a description will be given of the image photographing situation of the customer by first and second cash register cameras 1b and 1c shown in FIG. 2. FIG. 3 is an explanatory diagram which shows the image photographing situation of customers by first and second cash register cameras 1b and 1c.

In the present embodiment, the accounting area is set in a range where customers who are carrying out the accounting at the cash register counter and customers waiting to carry out the accounting at the cash register counter are, and customers advancing into the accounting area are photographed by first cash register camera 1b and customers leaving the accounting area are photographed by second cash register camera 1c.

Here, when the number of customers waiting to carry out accounting at the cash register counter increases, a line is created by placing a customer who is carrying out the accounting at the cash register counter at the head, a customer positioned at the end of this line is photographed by first cash register camera 1b, the photographing area of first cash register camera 1b is set such that customers who head to the cash register counter are always photographed by first cash register camera 1b even in a state where there are no lines. In addition, the photographing area for second cash register camera 1c is set so as to mainly photograph images of the customer who is carrying out the accounting at the cash register counter.

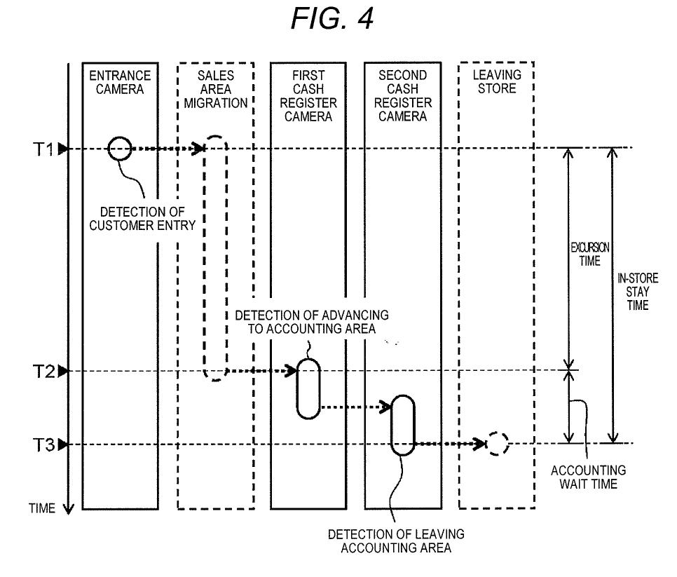

Next, a description will be given of an overview of processes performed by cameras 1a to 1c and PC 3 shown in FIG. 1. FIG. 4 is an explanatory diagram illustrating an outline of processes performed by cameras 1a to 1c and PC 3.

First, when a customer enters the store from an entrance, an image of the customer is photographed by entrance camera 1a. Next, the customer who entered the store migrates around the sales area searching for the desired product and, when the desired product is found, takes the product to the cash register counter. At this time, an image of the customer advancing into the accounting area is photographed by first cash register camera 1b. Customers who have finished the accounting at the cash register counters go to the exit to leave the store. At this time, an image of the customer leaving the accounting area is photographed by second cash register camera 1c.

In PC 3, person detection for detecting a person from each photographed image of entrance camera 1a, first cash register camera 1b, and second cash register camera 1c and person verification for verifying a person detected from each photographed image are performed and the customer's behavior in the store is detected in accordance with the result of this person verification.

First, when a person is detected from the photographed image of entrance camera 1a, it is detected that the customer has entered the store and this person is registered as a customer staying in the store. At this time, a face image (image of the face region) is acquired from the photographed image, and the face image and personal feature information extracted from the face image are stored as customer information, specifically, first customer image information, which includes feature amounts (unique values) of the face image and a store entry time T1 acquired from the photograph time of the photographed image.

Next, when a person is detected from the photographed image of first cash register camera 1b, the face image is acquired from the photographed image, person verification is performed which compares and verifies personal feature information extracted from the face image and personal feature information of each customer already registered, and when the person verification succeeds, it is detected that the customer who entered the store has advanced into the accounting area and the registration information of the customer is updated. At this time, second customer image information, which includes the face image, the personal feature information extracted from the face image, and an accounting wait start time T2 acquired from the photograph time of the photographed image, is stored as customer information.

Next, when a person is detected from the photographed image of second cash register camera 1c, a face image is acquired from the photographed image, person verification is performed which compares and verifies personal feature information extracted from the face image and personal feature information of each customer already registered, and when the person verification succeeds, it is detected that the customer who advanced into the accounting area after entering the store has left the accounting area, and the registration information of the customer is updated. At this time, third customer image information including the face image, the personal feature information extracted from the face image, and the accounting wait end time T3 acquired from the photograph time of the photographed image is stored as customer information.

Next, PC 3 calculates the excursion time (=T2−T1) from the store entry time T1 and the accounting wait start time T2. In addition, an accounting wait time (=T3−T2) is calculated from the accounting wait start time T2 and the accounting wait end time T3.

Here, in first cash register camera 1b, the customer who has entered the accounting area is continuously photographed, but the photograph time of the photographed image when the customer advances into the photographing area of first cash register camera 1b and the customer is initially detected in the photographed image of first cash register camera 1b may be set as the accounting wait start time T2. In addition, in second cash register camera 1c, images of the customer are continuously photographed until the customer leaves the accounting area, but the photograph time of the photographed image directly before the customer leaves the photographing area of second cash register camera 1c and the customer disappears in the photographed image of second cash register camera 1c may be set as the accounting wait end time T3.

In addition, the accounting wait time (=T3−T2) is calculated from the accounting wait start time T2 and the accounting wait end time T3, but this accounting wait time includes not only the line wait time in the accounting area, but the accounting work time, that is, the time when the store clerk inputs the price and the number of the product to the POS terminal and receives the purchase price of the product from the customer.

Here, it is also possible to not include the accounting work time in the accounting wait time, that is, it is also possible to set the accounting wait time as the wait time until the store clerk starts the accounting work after queuing in the line of the cash register counter, and in this case, the photographing area of second cash register camera 1c may be set so as to advance into the photographing area of second cash register camera 1c when the customer comes to a position facing the store clerk who performs the accounting work with the cash register counter interposed therebetween, and a timing when a person advances into the photographing area of second cash register camera 1c and the customer is initially detected in the photographed image of second cash register camera 1c is the accounting wait end time T3.

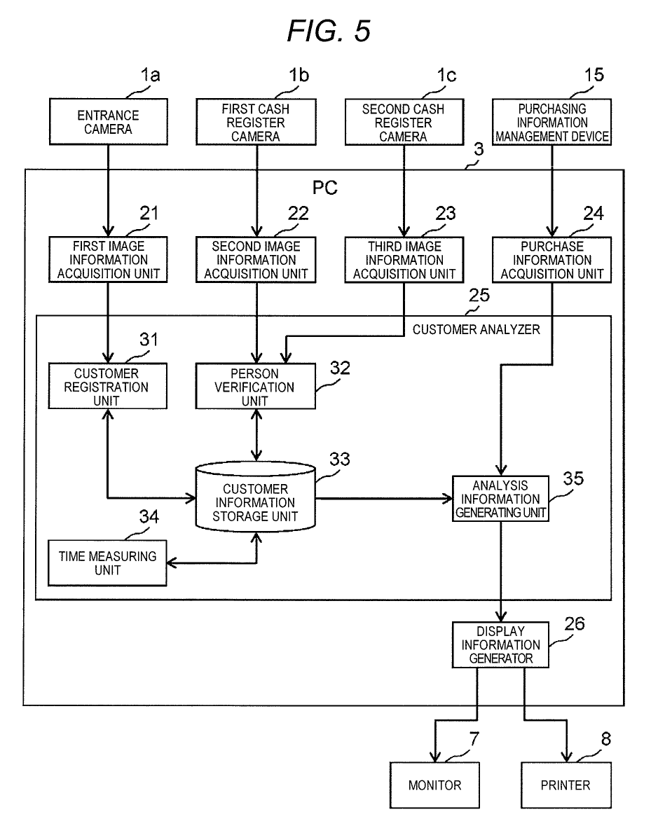

Next, a detailed description will be given of the schematic configuration of PC 3 shown in FIG. 1. FIG. 5 is a functional block diagram which shows the schematic configuration of PC 3.

PC 3 is provided with first image information acquisition unit 21, second image information acquisition unit 22, third image information acquisition unit 23, purchase information acquisition unit 24, customer analyzer 25, and display information generator (analysis information presentation unit) 26.

First image information acquisition unit 21 acquires the first customer image information related to the photographed image of the customer at the time of entering the store. In the present embodiment, an image of a customer who enters from the entrance of the store is photographed by entrance camera 1a, and first image information acquisition unit 21 performs a person detecting process of detecting a person from the photographed image input from entrance camera 1a, a face image cropping process of cropping a face image of a person from a photographed image, and a feature extracting process of analyzing the face image of a person to acquire personal feature information, and outputs the face image, the personal feature information, and the photograph time as first customer image information.

Second image information acquisition unit 22 acquires second customer image information related to the photographed image of the customer at the time of advancing into the accounting area. In the present embodiment, an image of a customer advancing into the accounting area is photographed by first cash register camera 1b, and second image information acquisition unit 22 performs a person detecting process of detecting a person from the photographed image input from first cash register camera 1b, a face image cropping process of cropping a face image of a person from a photographed image, and a feature extracting process of analyzing the face image of a person to acquire personal feature information, and outputs the face image, the personal feature information, and the photograph time as second customer image information.

Third image information acquisition unit 23 acquires third customer image information related to the photographed image of the customer at any point in time from the start of the store clerk's accounting work for the purchased product until the customer leaves the accounting area. In the present embodiment, an image of a customer leaving the accounting area is photographed by second cash register camera 1c, and third image information acquisition unit 23 performs a person detecting process, of detecting a person from the photographed image input from second cash register camera 1c, a face image cropping process of cropping a face image of a person from a photographed image, and a feature extracting process of analyzing the face image of a person to acquire personal feature information, and outputs the face image, the personal feature information, and the photograph time as third customer image information.

Purchase information acquisition unit 24 acquires purchase information from purchase information management device 15 which manages purchase information related to the product purchase status for each customer. In the present embodiment, the purchase price, the number of purchased products, and the accounting time for each customer are acquired from purchase information management device 15 as purchase information.

Purchase information management device 15 is a so-called POS server forming a POS (point of sale) system (sales information management system), and is installed in the head office. In the store, a store clerk operates a POS terminal installed in the cash register counter to perform the accounting work for the product, and purchase information for each customer is transmitted from the POS terminal to purchase information management device 15 and, purchase information management device 15 stores and manages purchase information acquired from POS terminals of each store. Here, purchase information acquisition unit 24 is also able to acquire purchase information directly from the POS terminal installed in the store.

Customer analyzer 25 is provided with customer registration unit 31, person verification unit 32, customer information storage unit 33, time measuring unit 34, and analysis information generator 35.

When customer registration unit 31 acquires the first customer image information (personal feature information and photograph time) from first image information acquisition unit 21, a process of registering the person as a visiting customer is performed. At this time, customer registration unit 31 stores a serial number assigned to the customer according to the arrival order and the store entry time acquired from the photograph time of the first customer image information as customer information in customer information storage unit 33. When it is detected by person verification unit 32 described below that the customer has left the accounting area, a process of deleting the registration information of the customer is performed in customer registration unit 31.

Here, among customers who visited the store, there are customers who leave without purchasing products, and the registration information of this customer is left without being deleted. Therefore, in the present embodiment, when acquiring the first customer image information from first image information acquisition unit 21, person verification is performed which determines whether or not the first customer image information relates to the same person as first customer image information previously stored in customer information storage unit 33, and, in a case where the person is the same, registration information related to the previously stored first customer image information is deleted and a new customer is registered using the latest first customer image information, and the store entry time is acquired based on the latest first customer image information. Alternatively, the first customer image information previously stored in customer information storage unit 33 for each business day of the store may be deleted, or the first customer image information may be deleted after a predetermined time (for example, three hours) passes from the registration in customer information storage unit 33.

Here, in customer registration unit 31, in order to avoid registering the store clerk as a customer, processing to eliminate store clerks may be performed. In this case, a store clerk is registered in advance using store clerk image information obtained by photographing an image of the store clerk, person verification is performed between the first customer image information and the store clerk image information to distinguish whether or not the person entering the store is a store clerk, and the person may be registered as a customer when the person entering the store is not a store clerk.

When person verification unit 32 acquires the second customer image information (personal feature information and photograph time) from second image information acquisition unit 22, person verification is performed between the second customer image information and the first customer image information related to the registered person, and when the person verification succeeds, it is detected that the customer who entered the store has advanced into the accounting area and the accounting wait start time acquired from the photograph time of the second customer image information is stored in customer information storage unit 33 as customer information.

In addition, when person verification unit 32 acquires third customer image information (personal feature information and photograph time) from third image information acquisition unit 23, person verification is performed between the third customer image information and the first customer image information or second customer image information related to a registered person and, when the person verification succeeds, it is detected that the customer who advanced into the accounting area after entering the store has left the accounting area, and the accounting wait end time acquired from the photograph time of the third customer image information is stored in customer information storage unit 33 as customer information.

Each of first, second, and third image information acquisition units 21 to 23 acquires a face image of the person every time a person is detected from the photographed image by person tracking, and a plurality of face images each related to one person are acquired when the person enters the store, advances into the accounting area, and leaves the accounting area. Then, when person verification unit 32 calculates the similarity between the plurality of face images at the time of entering the store and the plurality of face images at the time of advancing into the accounting area and the similarity becomes equal to or larger than a predetermined threshold value, two face images are judged to be the same person, and in addition, when a similarity is calculated between a plurality of face images at the time of entering the store or entering the accounting area and a plurality of face images at the time of leaving the accounting area and the similarity becomes equal to or larger than a predetermined threshold value, two face images are judged to be the same person. In this manner, performing person verification using a plurality of face images makes it possible to suppress person verification errors.

Time measuring unit 34 acquires the store entry time, the accounting wait start time, and the accounting wait end time for each customer from customer information storage unit 33, calculates the excursion time from the store entry time and the accounting wait start time, and, in addition, calculates the accounting wait time from the accounting wait start time and the accounting wait end time.

Analysis information generator 35 performs a process of correlating the excursion time and the accounting wait time for each customer acquired by time measuring unit 34 with the purchase price and number of purchased products (purchase information) for each customer acquired by purchase information acquisition unit 24 for the same person. This correlation process is performed based on the third customer image information, specifically, the accounting wait end time acquired from the photograph time of the third customer image information is compared with the accounting time acquired by purchase information acquisition unit 24 to judge whether customers close to each other are the same person.

In addition, analysis information generator 35 collects the excursion time and the accounting wait time for each customer for each unit of time (for example, one hour), and performs a collection process of acquiring the average excursion time and the average accounting wait time for each unit of time. In addition, a collection process is carried out in which the purchase price for each customer and the number of purchased products are collected for each unit of time (for example, one hour) to acquire the average purchase price and the average number of purchased products per unit of time.

Display information generator 26 performs a process of generates display information related to the analysis information generated by analysis information generator 35 and outputting the display information to monitor 7 and printer 8. In the present embodiment, display information for printer 8 to output a form representing analysis information is generated. In addition, display information for displaying a screen displaying analysis information on monitor 7 is generated.

Here, each part of PC 3 shown in FIG. 3 is realized by executing a program (instructions) for analyzing customer behavior stored in a memory such as an HDD using a processor (CPU) of PC 3. These programs may be configured as a dedicated device introduced to PC 3 in advance as an information processing device, or may be provided to the user by being recorded on an appropriate program recording medium as an application program operating on a predetermined OS, or through a network.

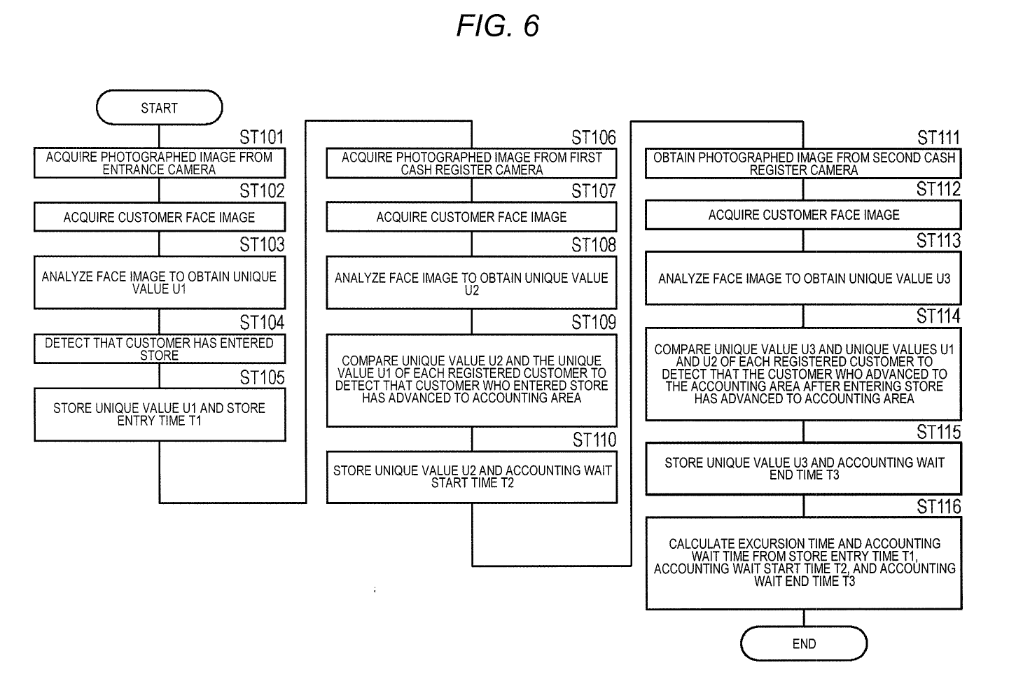

Next, a description will be given of the process related to the time measurement performed in PC 3 shown in FIG. 1. FIG. 6 is a flowchart which shows an order of processes related to time measurement performed in PC 3.

First, first image information acquisition unit 21 acquires a photographed image from entrance camera 1a (ST 101), then acquires a customer's face image from the photographed image (ST 102), and then analyzes the face image to obtain a unique value U1 (ST 103).

Next, when customer registration unit 31 acquires the unique value U1 from first image information acquisition unit 21, customer registration unit 31 detects that a customer has entered the store (ST 104). Then, the store entry time T1 of the customer is acquired from the photograph time of the face image, and the store entry time T1 and the unique value U1 are stored in customer information storage unit 33 (ST 105).

Next, second image information acquisition unit 22 acquires a photographed image from first cash register camera 1b (ST 106), then acquires a customer's face image from the photographed image (ST 107), and then analyzes the face image to obtain a unique value U2 (ST 108).

Next, when person verification unit 32 acquires the unique value U2 from second image information acquisition unit 22, the unique value U2 is compared with the unique value U1 of each registered customer, and it is detected that the customer who entered the store has advanced into the accounting area (ST 109). Then, the accounting wait start time T2 of the customer is acquired from the photograph time of the face image, and the accounting wait start time T2 and the unique value U2 are stored in customer information storage unit 33 (ST 110).

Next, third image information acquisition unit 23 acquires a photographed image from second cash register camera 1c (ST 111), then acquires the customer's face image from the photographed image (ST 112), and then analyzes the face image to obtain a unique value U3 (ST 113).

Next, when person verification unit 32 acquires the unique value U3 from third image information acquisition unit 23, person verification unit 32 compares the unique value U3 with the unique values U1 and U2 of each registered customer and detects that the customer who advanced into the accounting area after entering the store has left the accounting area (ST 114). Then, the accounting wait end time T3 of the customer is acquired from the photograph time of the face image, and the accounting wait end time T3 and the unique value U3 are stored in customer information storage unit 33 (ST 115).

Next, time measuring unit 34 calculates the excursion time (=T2−T1) from the store entry time T1 and the accounting wait start time T2 and, in addition, calculates the accounting wait time (T3−T2) from the accounting wait start time T2 and the accounting wait end time T3 (ST 116).

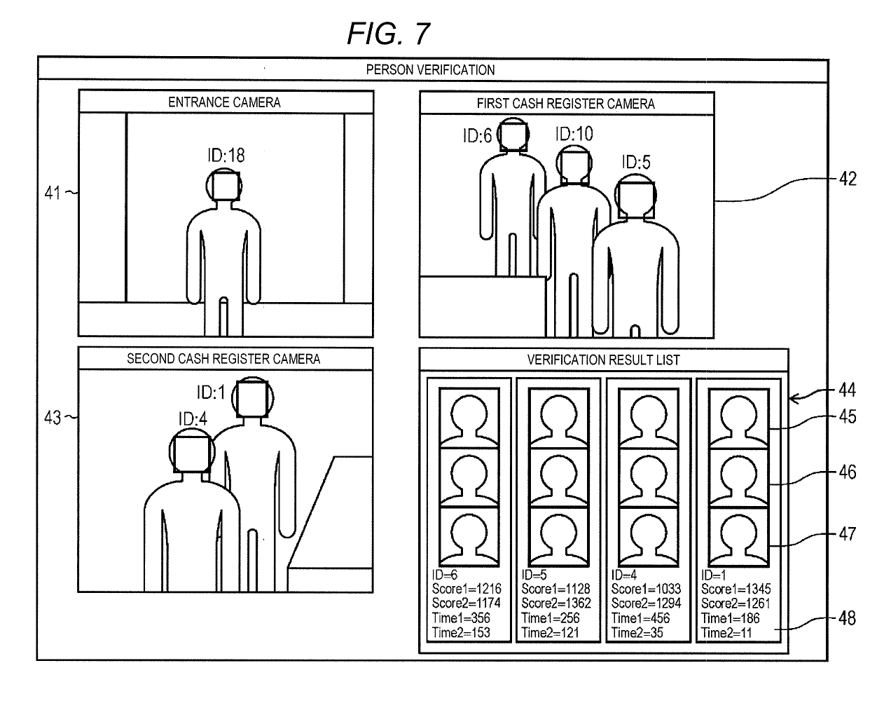

Next, a description will be given of a person verification screen that displays the status of the person verification process performed by person verification unit 32 shown in FIG. 5. FIG. 7 is an explanatory diagram which shows a person verification screen displayed on monitor 7.

The personal verification screen includes first, second, and third photographed image display units 41 to 43 and verification result list display unit 44.

In first photographed image display unit 41, a photographed image at the time of entering the store, which is photographed by entrance camera 1a, of a customer who entered the store from the entrance of the store is displayed. In second photographed image display unit 42, a photographed image at the start of the accounting wait, which is photographed by first cash register camera 1b, of a customer who advanced into the accounting area is displayed. In third photographed image display unit 43, a photographed image at the accounting wait end time, which is photographed by second cash register camera 1c, of the customer leaving the accounting area, is displayed.

Here, the photographed images may be displayed on first, second, and third photographed image display units 41 to 43 as a moving image. In this case, if work buttons such as play, reverse play, stop, fast forward, and rewind are provided, it is possible to efficiently confirm the person verification status.

Verification result list display unit 44 displays the results of the person verification process performed by person verification unit 32 for each person determined as the same person by the person verification and is provided with first, second, and third face image display units 45 to 47, and verification result display unit 48.

First, second, and third face image display units 45 to 47 display face images of the customer at the time of entering the store extracted from the photographed images displayed on each of first, second, and third photographed image display units 41 to 43, face images of the customer at the accounting wait start time, and face images of the customer at the accounting wait end time.

Verification result display unit 48 displays, as verification result information, personal identification information (ID allocated to each person), a similarity of a person (Score 1) between each face image at the time of entering the store and at the accounting wait start time, a similarity of a person (Score 2) between each face image at the time of entering the store (or at the accounting wait start time) and at the accounting wait end time, the excursion time, that is, the time from entering the store to advancing into the accounting area (Time 1), and the accounting wait time, that is, the time from advancing into the accounting area to leaving the accounting area (Time 2).

This person verification screen allows the user to confirm the status of person verification performed by person verification unit 32, that is, whether or not person verification has been properly executed.

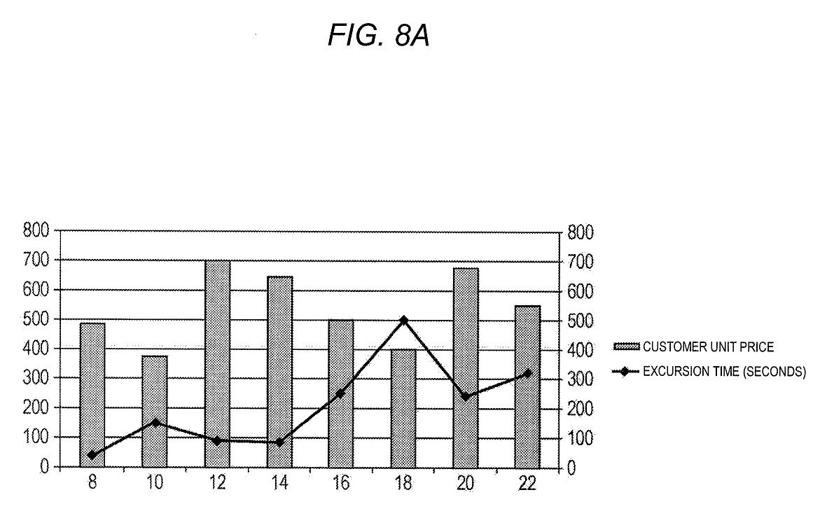

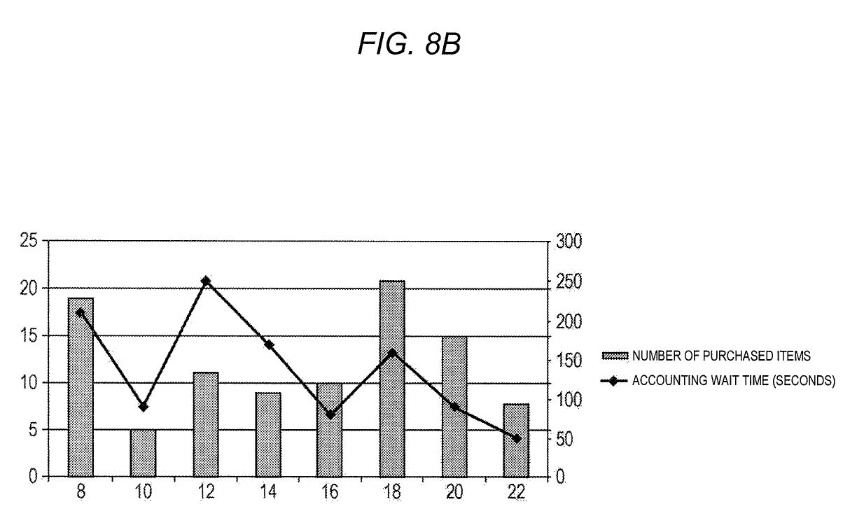

Next, a description will be given of the analysis information generated by analysis information generator 35 shown in FIG. 5. FIGS. 8A and 8B are explanatory diagrams showing a form which shows analysis information output by printer 8.

In the present embodiment, analysis information generator 35 collects the excursion time for each customer for each time period (one hour), acquires the average excursion time for each time period, and also collects the purchase price for each customer for each time period (one hour) to acquire the average purchase price (customer unit price) for each time period, and, due to this, the graph shown in FIG. 8A is generated in display information generator 26 and output by printer 8. At this time, analysis information generator 35 extracts customers who performed accounting for each time period based on the accounting time for each customer, and the average excursion time and the average purchase price for each time period may be determined by averaging the excursion time and the purchase price for each customer.

From this graph, it is possible to grasp the temporal transition status of the average excursion time and average purchase price (customer unit price) for each time period. Then, comparing the average excursion time and the average purchase price for each time period makes it possible to grasp the opportunity loss situation in the store.

For example, in the time period of 12 o'clock, since the excursion time is short and the customer unit price is high, it is assumed that the products desired by the customers are quickly found, which is a desirable state. On the other hand, in the time period at 18 o'clock, since the excursion time is long and the customer unit price is low, the products desired by the customers are not in the store, thus it is assumed that the customers were undecided with regard to the selection of products, and it is considered that opportunity loss occurred, therefore it is necessary to review the product selection and investigate improving the work so as to quickly replenish missing products.

In addition, in the present embodiment, analysis information generator 35 collects the accounting wait time for each customer for each time period (one hour), acquires the average accounting wait time for each time period, and, in addition, collects the number of purchased products for each customer for each time period (one hour) so as to acquire the average number of purchased products for each time period, and, due to this, the graph shown in FIG. 8B is generated by display information generator 26 and output by printer 8. At this time, analysis information generator 35 extracts customers who performed accounting for each time period based on the accounting time for each customer, and the average accounting wait time and the average number of purchased products for each time period may be determined by averaging the accounting wait time and number of purchased products for each customer.

From this graph, it is possible to grasp the temporal transition status of the average accounting wait time and the average number of purchased products for each time period. Then, comparing the average accounting wait time and the average number of purchased products for each time period makes it possible to grasp the opportunity loss situation.

For example, in the time period of 8 o'clock, the number of purchased products is large and the accounting wait time is long, but this is because many customers tried to purchase a large number of products, thus, it is assumed that the accounting wait time is longer as a result of taking time for the accounting work. On the other hand, in the time period at 12 o'clock, although the number of purchased products is small, the accounting wait time is long, and it is assumed that this is because there are many customers waiting for the accounting and customers refrained from buying, since it is considered that opportunity loss has occurred, it is necessary to consider improvement of personnel allocation to reduce the accounting wait time.

In the examples shown in FIG. 8A and FIG. 8B, the collection unit period is set as a time period (one hour), but the collection unit period may be set to one day, one week, one month, or the like. In addition, here, the form representing the analysis information is output by printer 8, but a screen representing the analysis information may be displayed on monitor 7.

In addition, when considering only acquiring collection values for each time period, a process to correlate the excursion time and accounting wait time for each customer and the purchase price and the number of purchased products for each customer with the same person is not particularly necessary. That is, if the excursion time and the accounting wait time for each customer and the purchase price and the number of purchased products for each customer are collected separately for each time period, it is possible to acquire the average excursion time, the average accounting wait time, the average purchase price, and the average number of purchased products for each time period. However, as the accounting wait time becomes longer, the time lag becomes larger, thus, in order to accurately carry out collection for each time period, it is necessary to make a correlation with each customer.

As described above, in the present embodiment, first image information acquisition unit 21 acquires the first customer image information related to the photographed image of the customer at the time of entering the store, and second image information acquisition unit 22 acquires the second customer image information related to the photographed image of the customer at the time of advancing into the accounting area, and third image information acquisition unit 23 acquires third customer image information related to the photographed image of the customer at any point in time from starting the accounting work for the product to be purchased until leaving the accounting area, purchase information acquisition unit 24 acquires purchase information related to the customer's product purchase status, and customer analyzer 25 measures the excursion time for each customer based on the first and second customer image information and correlates the excursion time and the purchase information for each customer based on the third customer image information, generates analysis information representing the relationship between customer behavior in the store and the product purchase status and display information generator (analysis information presentation unit) 26 presents the analysis information generated by customer analyzer 25 to the user. According to this, based on the video photographed in the store, the excursion time for each customer is measured, and this excursion time and purchase information for each customer are correlated, thus it is possible to obtain analysis information making it possible for the user to accurately grasp the opportunity loss situation in the store.

In addition, in the present embodiment, purchase information acquisition unit 24 acquires the purchase price for each customer as purchase information, and customer analyzer 25 generates analysis information by correlating the excursion time and the purchase price for each customer. According to this, analysis information is generated by correlating the excursion time and purchase price for each customer, thus, it is possible for the user to accurately grasp the opportunity loss situation in the store.

In addition, in the present embodiment, purchase information acquisition unit 24 acquires the number of purchased products for each customer as purchase information, and customer analyzer 25 measures the accounting wait time for each customer based on the second and third customer image information to generate analysis information by correlating the accounting wait time and the number of purchased products for each customer. According to this, since the analysis information is generated by correlating the accounting wait time and the number of purchased products for each customer, it is possible for the user to accurately grasp the opportunity loss situation in the store.

In addition, in the present embodiment, in a case where the first customer image information newly acquired by first image information acquisition unit 21 is for the same person as previously acquired first customer image information, customer analyzer 25 measures the excursion time based on the latest first customer image information. According to this, it is possible to avoid erroneous measurement of the excursion time based on the previously acquired first customer image information.

In addition, in the present embodiment, customer analyzer 25 collects the excursion time and the purchase price for each customer for each predetermined unit periods, calculates the average excursion time for each unit period and customer unit price which is the average purchase price for each unit period, and generates display information in which the temporal transition status of the average excursion time and the customer unit price is displayed in a comparable manner as the analysis information. According to this, since the temporal transition status of the average excursion time and the customer unit price are displayed in a comparable manner, it is possible for the user to accurately grasp the opportunity loss situation in the store.

In addition, in the present embodiment, customer analyzer 25 collects the accounting wait time and the number of purchased products for each customer and for each predetermined unit period to calculate the average accounting wait time for each unit period and the customer unit price which is the average number of purchased products for each unit period, and, generates display information in which the temporal transition status of the average accounting wait time and the average number of purchased products is displayed in a comparable manner as the analysis information. According to this, since the temporal transition status of the average accounting wait time and the average number of purchased products are displayed in a comparable manner, it is possible for the user to accurately grasp the opportunity loss situation in the store.

Although the present invention was described based on specific embodiments, these embodiments are merely examples, and the present invention is not limited by these embodiments. In addition, the respective constituent elements of the customer behavior analysis device, the customer behavior analysis system, and the customer behavior analysis method according to the present invention described in the above embodiments are not necessarily all essential, and it is possible to appropriately discard and select the above at least without departing from the scope of the present invention.

For example, in the present embodiment, as shown in FIG. 2, camera 1 is a box-type camera whose viewing angle is limited, but it is not limited thereto, and it is also possible to use an omnidirectional camera capable of photographing images in a wide range.

In addition, in the present embodiment, first to third image information acquisition units 21 to 23 perform a person detecting process of detecting a person from the photographed images of cameras 1a to 1c, a face image cropping process of cropping a face image of a person from a photographed image, and a feature extracting process of acquiring personal feature information (unique values) by analyzing face images of a person; however, but all or part of the person detecting process, the face image cropping process, and the feature extracting process may be performed by cameras 1a to 1c. In addition, all or a part of the person detecting process, the face image cropping process, and the feature extracting process may be performed by a dedicated device different from PC 3 and cameras 1a to 1c. In this case, first to third image information acquisition units 21 to 23 of PC 3 acquire the first to third customer image information output from cameras 1a to 1c and dedicated devices.

In addition, in the present embodiment, third image information acquisition unit 23 acquires the third customer image information related to the photographed image of the customer at the time of leaving the accounting area, but this third customer image information may be related to the photographed image of the customer at any point in time from the start of the store clerk's accounting work for the purchased product until the customer leaves the accounting area. Acquiring such third customer image information makes it possible to judge whether or not the customer has finished paying and it is possible to correlate the excursion time and the purchase information by regarding the photograph time of this third customer image information as the accounting time.

In addition, in the present embodiment, the process necessary for the customer behavior analysis is performed by a device installed in the store; however, these necessary processes may be performed by cloud computer 12 formed of PC 11 provided in the head office as shown in FIG. 1 and a cloud computing system. In addition, a plurality of information processing devices may share the necessary processes and the information may be sent and received between the plurality of information process devices via a communication medium such as an IP network or a LAN, or a storage medium such as a hard disk or a memory card. In this case, the customer behavior analysis system is formed of a plurality of information processing devices which share necessary processing.

In particular, in the system configuration including cloud computer 12, in addition to PCs 3 and 11 provided in the stores and head office, it may be possible to display the necessary information on portable terminals such as smart phones 13 and or tablet terminals 14 connected by a network to cloud computer 12, and due to this it is possible to view the analysis information at any location such as outside in addition to the store or the head office.

In addition, in the above embodiment, recorder 2 for storing the video of camera 1 is installed in the store; however, in a case where PC 11 or cloud computer 12 installed in the head office performs the processes necessary for customer behavior analysis, the video of camera 1 may be transmitted to the head office, the management facility of the cloud computing system, or the like, and the video of camera 91 may be stored in a device installed therein.

### INDUSTRIAL APPLICABILITY

The customer behavior analysis device and the customer behavior analysis system according to the present invention have an effect of making it possible to obtain analysis information making it possible for the user to accurately grasp the opportunity loss situation in a store based on video photographed in the store, and is useful as a customer behavior analysis device and a customer behavior analysis system which analyze the relationship between customer behavior and product purchase status in a store based on the video photographed in the store.

### REFERENCE MARKS IN THE DRAWINGS

1a ENTRANCE CAMERA
1b FIRST CASH REGISTER CAMERA
1c SECOND CASH REGISTER CAMERA
3 PC (CUSTOMER BEHAVIOR ANALYSIS DEVICE)
7 MONITOR (DISPLAY DEVICE)
8 PRINTER
11 PC
12 CLOUD COMPUTER
13 SMART PHONE
14 TABLET TERMINAL
15 PURCHASE INFORMATION MANAGEMENT DEVICE
21 FIRST IMAGE INFORMATION ACQUISITION UNIT
22 SECOND IMAGE INFORMATION ACQUISITION UNIT
23 THIRD IMAGE INFORMATION ACQUISITION UNIT
24 PURCHASE INFORMATION ACQUISITION UNIT
25 CUSTOMER ANALYZER
26 DISPLAY INFORMATION GENERATOR (ANALYSIS INFORMATION PRESENTATION UNIT)

1. A customer behavior analysis device which analyzes a relationship between a customer behavior and a product purchase status in a store on the basis of video photographed in the store, the device comprising:
a processor; and
a memory that stores instructions,
wherein the processor executes the following as instructions stored in the memory,
acquiring first customer image information related to a photographed image of a customer when entering a store,
acquiring second customer image information related to a photographed image of the customer when advancing into an accounting area,
acquiring third customer image information related to a photographed image of the customer at any point in time from a start of accounting work of a purchased product until leaving the accounting area,
acquiring purchase information related to a product purchase status of a customer,
measuring an excursion time for each customer on the basis of the first and second customer image information, correlating the excursion time and purchase information for each customer on the basis of the third customer image information, and generating analysis information in which the excursion time and purchase information for each customer are collected, and
presenting the analysis information to a user.

2. The customer behavior analysis device of claim 1,
wherein a purchase price for each customer is acquired as purchase information and analysis information is generated by correlating the excursion time and the purchase price for each customer.

3. The customer behavior analysis device of claim 1,
wherein a number of purchased products for each customer is acquired as the purchase information, and
an accounting wait time for each customer is measured on the basis of the second and third customer image information, and the analysis information is generated by correlating the accounting wait time and the number of purchased products for each customer.

4. The customer behavior analysis device of claim 1,
wherein when newly acquired first customer image information is for the same person as previously acquired first customer image information, the excursion time is measured based on the latest first customer image information.

5. The customer behavior analysis device of claim 2,
wherein the excursion time and the purchase price for each customer are collected for each predetermined unit period, an average excursion time for each unit period and a customer unit price which is an average purchase price for each unit period are calculated, and display information displaying temporal transition statuses of the average excursion time and the customer unit price in a comparable manner is generated as the analysis information.

6. The customer behavior analysis device of claim 3,
wherein the accounting wait time for each customer and the number of purchased products for each customer are collected for each predetermined unit period, an average accounting wait time for each predetermined unit period and an average number of purchased products for each predetermined unit period are calculated, and display information displaying temporal transition statuses of the average accounting wait time and the average number of purchased products in a comparable manner is generated as the analysis information.

7. A customer behavior analysis system which analyzes a relationship between a customer behavior and a product purchase status in a store on the basis of video photographed in the store, the system comprising:
a camera that photographs an interior of the store; and
a plurality of information processing devices provided with a processor and a memory which stores instructions,
wherein any one of the plurality of information processing devices executes the following as the instructions stored in the memory by the processor,
acquiring first customer image information related to a photographed image of a customer when entering a store,
acquiring second customer image information related to a photographed image of the customer when advancing into an accounting area,
acquiring third customer image information related to a photographed image of the customer at any point in time from a start of accounting work of a purchased product until leaving the accounting area,
acquiring purchase information related to a product purchase status of a customer,
measuring an excursion time for each customer on the basis of the first and second customer image information, correlating the excursion time and purchase information for each customer on the basis of the third customer image information, and generating analysis information in which the excursion time and purchase information for each customer are collected, and
presenting the analysis information to a user.
